(19) United States
(12) Patent Application Publication
(10) Pub. No.: US 2008/0008145 A1
(43) Pub. Date: Jan. 10, 2008

(54) Mobile radio terminal apparatus and address resolution method

(75) Inventor: Shinichi Shishino, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA

(21) Appl. No.: 11/516,304

(22) Filed: Sep. 5, 2006

(30) Foreign Application Priority Data
Jul. 5, 2006 (JP) 2006-185899

(51) Int. Cl. H04Q 7/24

(52) U.S. Cl. 370/338; 370/395.53; 455/425

(57) ABSTRACT

As means for conducting address resolution corresponding to each of application servers to be connected to network applications, respectively, a the address resolution sub-unit, an IP protocol stack sub-unit, and an address resolution sub-unit, an IP protocol stack sub-unit, are provided such that the address resolution is conducted for each connection.

### CROSS-REFERENCE TO RELATED APPLICATIONS

This application is based upon and claims the benefit of priority from prior Japanese Patent Application No. 2006-185899, filed Jul. 5, 2006, the entire contents of which are incorporated herein by reference.

### BACKGROUND OF THE INVENTION

1. Field of the Invention

This invention relates to a mobile radio terminal apparatus such as a cellular telephone, capable of conducting IP communications using a plurality of data links.

2. Description of the Related Art

To connect to an IP (Internet Protocol) network, address resolution of converting a host name into an IP address is an indispensable technique (refer to, for example, Jpn. Pat. Appln. KOKAI Publication No. 2001-103092). In the general IP connection, there is a single connection link (data link) from a terminal to a network. The address resolution is conducted by using a DNS (Domain Name System) server of the connected network.

In a radio communication scheme such as W-CDMA (Wideband Code Division Multiple Access), the IP communications can be conducted by employing a plurality of data links called multiple PDP (Packet Data Protocol) context. Even in this communication system, however, since only one address resolution means for conducting the address resolution can be provided in general, the address resolution cannot be appropriately conducted when the data link is connected to a plurality of different networks.

For example, it is considered that, at a terminal, a plurality of applications are simultaneously connected to different closed networks A, B by using the multiple PDP context. If the address resolution means uses the DNS server of the network A under such conditions, the address resolution for the network A can be conducted. However, in a case where the information of the other network B is not stored, the address resolution or the connection to the network cannot be conducted. If the same host name exists in both the networks A, B, connection to the host of the network B cannot be conducted or an improper connection may be caused since the address resolution means obtains the address of the host of the network A.

In the conventional mobile radio terminal apparatus, the address resolution cannot be appropriately conducted in a case of simultaneously connecting to a plurality of different networks.

### BRIEF SUMMARY OF THE INVENTION

The present invention has been accomplished to solve the above-described problems. The object of the present invention is to provide a mobile radio terminal apparatus and an address resolution method, capable of appropriately conducting address resolution even in a case of simultaneously connecting to a plurality of different networks.

To achieve this object, an aspect of the present invention is a mobile radio terminal apparatus, conducting radio communications with a radio base station and conducting communications with a network connector which is connected to a network via the radio base station. The apparatus comprises radio communication unit configured to establish a communication link with the radio base station, first communication unit configured to establish a first communication link with a first network connector, via the communication link, second communication unit configured to establish a second communication link with a second network connector via the communication link, first request control unit configured to transmit a host name to the first network connector via the first communication link and requesting an IP address, and second request control unit configured to transmit a host name to the second network connector via the second communication link and requesting an IP address.

According to this aspect of the present invention, the first communication link with the first network connecter is established and the second communication link with the second network connecter is established, over a communication link with a radio base station. The IP address is requested by transmitting the host name to the first network connecter by the first request control unit, and the IP address is requested by transmitting the host name to the second network connecter by the second request control unit.

Therefore, even when the first and second communication links are established for communications, the IP address can be requested by the network connecters connected to the respective communication links and the address resolution can be thereby conducted appropriately.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a mobile radio terminal apparatus according to an embodiment of the present invention;

FIG. 2 is a flowchart for explanation of operations of a connection session management unit in the mobile radio terminal apparatus shown in FIG. 1;

FIG. 3 is a connection state management table stored in the connection session management unit in the mobile radio terminal apparatus shown in FIG. 1;

FIG. 4 is a connection state management table stored in the connection session management unit in the mobile radio terminal apparatus shown in FIG. 1;

FIG. 5 is a flowchart for explanation of operations of the connection session management unit in the mobile radio terminal apparatus shown in FIG. 1; and

FIG. 6 is a flowchart for explanation of operations of an address resolution main unit in the mobile radio terminal apparatus shown in FIG. 1.

### DETAILED DESCRIPTION OF THE INVENTION

An embodiment of the present invention will be explained below with reference to the accompanying drawings.

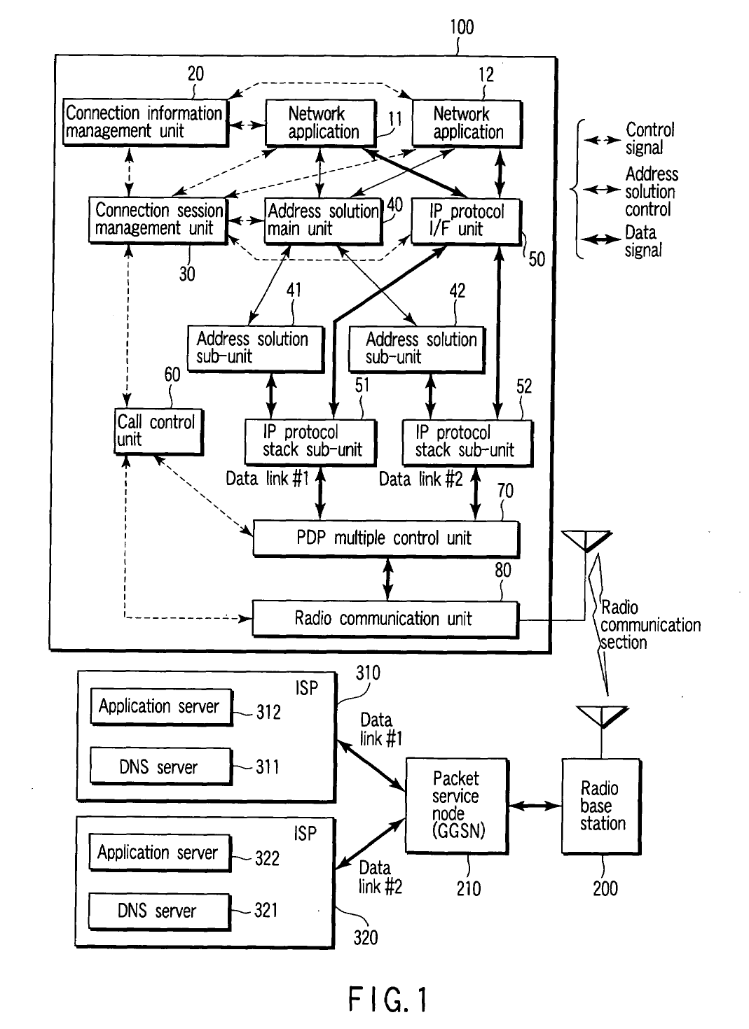

FIG. 1 shows a configuration of a mobile radio terminal apparatus 100 according to the embodiment of the present invention. The mobile radio terminal apparatus 100 makes access to application servers 312, 322 in ISP 310 and ISP 320, via a radio base station 200 and a packet service node (GGSN) 210 which are accommodated in a mobile communication network.

The packet service node 210 is a node forming a packet network of the mobile communication network, i.e. GGSN (Gateway GPRS Support Node), which is a node connected to an ISP (Internet Service Provider) or an intracorporate network provided for connection to the Internet in a GPRS (General Packet Radio Service) environment.

The ISP 310 and the ISP 320 are Internet service providers comprising a DNS server 311 and the application server 312, and a DNS server 321 and the application server 322, respectively. The DNS servers 311, 321 maintain the host (server) names and IP addresses in the ISP 310 and the ISP 320 in association with each other, as name servers, and return the IP addresses in response to queries of the host (server) names.

The mobile radio terminal apparatus 100 comprises network applications 11 and 12, a connection information management unit 20, the connection session management unit 30, the address resolution main unit 40, address resolution sub-units 41 and 42, an IP protocol I/F unit 50, IP protocol stack sub-units 51 and 52, a call control unit 60, a PDP multiple control unit 70, and a radio communication unit 80.

For simple explanation, FIG. 1 mainly shows a configuration of the invention, which comprises, as constituent elements of a general cellular telephone, an operation unit accepting a request from a user by key operations, a display unit capable of displaying at least text information, a microphone, a speaker, etc. With these constituent elements, the mobile radio terminal apparatus 100 is capable of display and creation of electronic mails, web display of homepages, etc. as implemented by not only speech communications, but also data communications.

The network application 11 is an application program providing functions by having access to the application server 312 in the ISP 310. The network application 11 preliminarily stores an ISP identifier indicating the host name of the application server 312 and a location in the network at which the server is present. A software application such as a mailer or a browser is considered as an example of the application program.

Similarly to the network application 11, the network application 12 is an application program providing functions by having access to the application server 322 in the ISP 320. The network applications 11, 12 are programs of operating a CPU (Central Processing Unit) (not shown). FIG. 1 shows the network applications 11, 12 as the software applications, but the software shown in FIG. 1 represents the CPU operated by the software, for simple explanation.

The connection information management unit 20 stores connection information which is necessary to establish the data links with the ISP 310, ISP 320. When the connection information management unit 20 is notified of the ISP identifier from the network application 11 or the network application 12, the connection information management unit 20 notifies the network application 11 or the network application 12 of the connection information to the corresponding ISP. The data links are established by the connection in a radio section between the radio communication unit 80 and the radio base station 200, and by the connection in a cable section between the radio base station 200 and the ISP 310, ISP 320 via the packet service node 210. The connection information is a NAP (Network Access Point) profile including APN (Access Point Name) and QoS (Quality of Service) and is stored for each ISP in the connection information management unit 20.

The connection session management unit 30 manages the connection state of the data link established in response to the request from the network application 11 or 12 and stores a connection state management table. The connection session management unit 30 stores a set of the identifier and the connection state of the currently established data link, and the application identifier employing the data link, in association with one another.

The address resolution main unit 40 accepts a request for address resolution including the host name from the network application 11 or 12, controls the address resolution sub-unit 41 or 42 to obtain the address resolution result (IP address) in accordance with the request, and transmits the address resolution result (IP address) to the network application 11 or 12.

The address resolution sub-unit 41 or 42 is notified of a single DNS server address or a plurality of DNS server addresses at the establishment of the data link by the IP protocol stack sub-unit 51 or 52, and stores the DNS server address (or addresses) in its own memory. In accordance with an instruction of the address resolution main unit 40, the address resolution sub-unit 41 or 42 transmits a request for IP protocol control to the corresponding IP protocol stack sub-unit 51 or 52, takes out the address resolution result (IP address) included in a response signal responding to the request, and notifies the address resolution main unit 40 of the address resolution result (IP address).

The IP protocol I/F unit 50 is an interface which receives user data and a request for its transmission, or the IP protocol control request from the network application 11 or 12. The IP protocol I/F unit 50 transfers the user data and the request to the IP protocol stack sub-unit 51 or 52 corresponding to the data link identifier included in the request, and transmits the user data received from the IP protocol stack sub-unit 51 or 52 to the corresponding network application 11 or 12.

The IP protocol stack sub-unit 51 or 52 conducts protocol transmission of the control signal transmission request from the corresponding address resolution sub-unit 41 or 42, and the user data or the IP protocol control request transferred from the IP protocol I/F unit 50. The IP protocol stack sub-unit 51 or 52 generates an IP packet including these information items, and transmits the IP packet to the PDP multiple control unit 70 as an output of the corresponding data link.

In addition, the IP protocol stack sub-unit 51 or 52 receives the data transmitted from the PDP multiple control unit 70 as the IP packet, takes out the user data and the control signal by conducting the UP protocol reception, and transmits the user data and the control signal to the corresponding address resolution sub-unit 41 or 42 or the IP protocol I/F unit 50 after adding the data link identifier to the user data and the control signal.

The call control unit 60 conducts the communication control by employing the protocol for establishing the radio communication section and the cable section extending to the ISP 310 and ISP 320, and makes the connection in the radio communication section and the cable section. The call control unit 60 controls the connection state and the radio communication unit 80, in accordance with a response or an instruction which the call control unit 60 receives.

The PDP multiple control unit 70 demultiplexes physically and logically multiplexed data received from the radio base station 200, for each data link, and outputs the demultiplexed data to each of the IP protocol stack sub-units 51 and 52. In addition, the PDP multiple control unit 70 physically and logically multiplexes the user data which are input from the IP protocol stack sub-units 51 and 52 and transmits the multiplexed data to the radio base station 200, via the radio communication unit 80.

The radio communication unit 80, comprising a modem, conducts transmission and reception of the protocol data between the call control unit 60 and the radio base station 200, and encodes and modulates the data transmitted from the PDP multiple control unit 70 and transmits the encoded and modulated data to the radio base station 200 during the establishment of the data link. In addition, the radio communication unit 80 receives the multiplexed signal from the radio base station 200, and demodulates and decodes the multiplexed signal to obtain the receive data. The receive data thus obtained are output to the PDP multiple control unit 70.

Next, operations of the mobile radio terminal apparatus 100 having the above-described configuration are described.

First, operations in a case of employing the network application 11 are described. When the user operates an operation unit (not shown), the network application 11 notifies the connection information management unit 20 of the ISP identifier of the ISP 310 and obtains connection information #1 corresponding to the application from the connection information management unit 20, in order to connect to the application server 312 of the ISP 310. The network application 11 adds the application identifier to the connection information #1 and outputs the connection information #1 to the connection session management unit 30 to make a connection request.

When the connection session management unit 30 receives the connection request from the network application 11, the connection session management unit 30 checks whether the designated data link has already been established, by referring to the connection information #1 added to the connection request. The connection session management unit 30 queries the connection state management table to check whether the data link has already been established. If the data stored in the connection state management table include the information matching the connection information #1, the connection session management unit 30 discriminates that the data link #1 has already been established. If the data do not include such information, the connection session management unit 30 discriminates that the data link #1 has not yet been established.

In a case where the data link #1 has not yet been established, the connection session management unit 30 makes the connection request to the call control unit 60 by employing a parameter of the connection information #1. The call control unit 60 conducts the communication control by employing the protocol for establishing the connection in the radio communication section and the cable section extending to the ISP, and makes the connection in the radio communication section and the cable section.

For this reason, the call control unit 60 transmits the generated protocol data to the radio base station 200 and the packet service node 210 through the radio communication unit 80. The call control unit 60 also controls the connection state and the radio communication unit 80 in accordance with the response and instruction received from each of the units.

When the data link #1 is established, the call control unit 60 notifies the PDP multiple control unit 70 and the radio communication unit 80 that the data link #1 has been established, together with a parameter related with this connection, starts employment of the data link #1, and notifies the connection session management unit 30 of the establishment of connection together with the identifier of the employed data link #1.

The connection session management unit 30, receiving the notification, notifies the network application 11, which is the requester of the connection, of the establishment of connection to which the identifier of the data link #1 is added, and stores in the connections state management table a set of the identifier and connection information of the data link #1 and the identifier of the network application 11, which is the requester of the connection, in association with each other. When the connection is established, the connection session management unit 30 notifies the address resolution main unit 40 and the IP protocol I/F unit 50 of the identifier of the established data link #1.

If the connection in the data link #1 has already been established, the connection session management unit 30 notifies the network application 11 of the identifier of the data link #1 and the matter that the connection has already been established, and adds the identifier of the network application 11 to the set of the data including the data link #1 in the connection state management table.

When the establishment of the connection is completed, the address of the DNS server 311 of the ISP 310 is transmitted from the packet service node 210. At this time, the employment of the data link #1 for the connection with the ISP 310 is determined, as explained above. Therefore, the address is transferred to the address resolution sub-unit 41 via the radio communication unit 80, the PDP multiple control unit 70, and the IP protocol stack sub-unit 51.

The address resolution sub-unit 41 stores the address of the DNS 311 in the memory. When the address resolution sub-unit 41 conducts the address resolution, the address resolution sub-unit 41 makes query to the DNS server 311 on the basis of the address. When the data link is open, the address resolution sub-unit 41 erases the information on the address in the memory.

When the network application 11 receives notification of the establishment of connection of the data link #1 from the connection session management unit 30, the network application 11 outputs to the address resolution main unit 40 the identifier of the data link #1 which is output from the connection session management unit 30 and the address resolution request to which the host name is added, in order to obtain the IP address on the basis of the host name of the application server 312.

When the address resolution main unit 40 receives the address resolution request from the network application 11, the address resolution main unit 40 determines that the data link #1 is allocated to the address resolution sub-unit 41, from the data link identifier included in the address resolution request, and transfers the address resolution request to the address resolution sub-unit 41.

The address resolution sub-unit 41 creates a format for DNS server query from the parameter of the host name included in the transferred address resolution request, and transmits the IP protocol control request to the IP protocol stack sub-unit 51 corresponding to the data link #1 by regarding one of DNS server addresses prestored in the memory as a query server (DNS server 311 in this case).

When the IP protocol stack sub-unit 51 receives the IP protocol control request, the IP protocol stack sub-unit 51 packetizes this request and outputs the request to the PDP multiple control unit 70. The PDP multiple control unit 70 physically and logically multiplexes the packet data input from the IP protocol stack sub-unit 51 and transmits the multiplexed packet data to the radio base station 200 via the radio communication unit 80.

The packet data reaches the DNS server 311, in the data link #1 established between the packet service node 210 and the ISP 310, via the radio base station 200 and the packet service node 210. The DNS server 311 analyzes the packet data and detects the address resolution request. The DNS server 311 thereby queries the data which are stored in the DNS server 311 and detects the IP address of the application server 312, on the basis of the host name of the application server 312 included in the packet data.

The IP address of the application server 312 thus detected is packetized together with the control signal as a response signal, and is transmitted from the DNS server 311 to the mobile radio terminal apparatus 100, in the data link #1 established between the packet service node 210 and the ISP 310, via the radio base station 200 and the packet service node 210.

The radio communication unit 80 receives the radio signal transmitted from the radio base station 200, and demodulates and decodes the radio signal, and thereby obtains the data transmitted from the DNS server 311. Since the data are physically and logically multiplexed data, the data are demultiplexed for each data link by the PDP multiple control unit 70. The data of the data link #1, i.e. packet data transmitted from the DNS server 311, of the demultiplexed data, are output to the IP protocol stack sub-unit 51 to which the data link #1 has already been allocated.

The IP protocol stack sub-unit 51 takes out the control signal from the packet data, detects that the requester is the address resolution sub-unit 41, and transfers the packet data to the address resolution sub-unit 41. The address resolution sub-unit 41 takes out the address resolution result (IP address of the application server 312) included in the packet data and notifies the address resolution main unit 40 of the address resolution result.

The address resolution main unit 40 adds the identifier of the data link #1 to the address resolution result and notifies the network application 11, which is the requester, of the address resolution result as a result of the address resolution request. Thus, the network application 11 obtains the IP address of the application server 312 as a response to the address resolution request.

Subsequently, the network application 11 designates the IP address of the application server 312 obtained in the above manner, and the identifier of the data link #1, for the IP protocol I/F unit 50, and requests the connection and the data transmission/reception to the application server 312. After receiving this request, the IP protocol I/F unit 50 transfers the response from the application server 312 and the receive data to the network application 11.

When the IP protocol I/F unit 50 receives the user data and its transmission request, or the IP protocol control request from the network application 11, the IP protocol I/F unit 50 transfers the user data and the request to the IP protocol stack sub-unit 51 corresponding to the data link #1 included in the request.

The IP protocol stack sub-unit 51 conducts protocol transmission of the user data or the IP protocol control request transferred from the IP protocol I/F unit 50, creates the IP packet including these information items, and transmits the IP packet to the PDP multiple control unit 70 as the output of the corresponding data link #1.

The PDP multiple control unit 70 physically and logically multiplexes the user data input from the IP protocol stack sub-unit 51 and transmits the multiplexed user data to the radio base station 200 via the radio communication unit 80. The user data thereby reaches the application server 312, in the data link #1 established between the packet service node 210 and the ISP 310, via the radio base station 200 and the packet service node 210.

Oppositely, the user data transmitted from the application server 312 are packetized together with the control signal, and transmitted to the mobile radio terminal apparatus 100, in the data link #1 established between the packet service node 210 and the ISP 310, via the radio base station 200 and the packet service node 210.

The radio communication unit 80 receives the radio signal transmitted from the radio base station 200, and demodulates and decodes the radio signal, and thereby obtains the data transmitted from the application server 312. Since the data are physically and logically multiplexed data, the data are demultiplexed for each data link by the PDP multiple control unit 70.

The data of the data link #1, i.e. packet data transmitted from the application server 312, of the demultiplexed data, are output to the IP protocol stack sub-unit 51 to which the data link #1 has already been allocated.

The IP protocol stack sub-unit 51 takes out the user data and the control signal from the packet data by conducting the IP protocol reception, adds the identifier of the data link #1 to the user data and the control signal, and outputs the user data and the control signal to the IP protocol I/F unit 50. The IP protocol I/F unit 50 adds the identifier of the data link #1 corresponding to the IP protocol control signal to the user data input from the IP protocol stack sub-unit 51, and outputs the user data to the network application 11. As described above, the user data are transmitted and received in the data link #1, between the network application 12 and the application server 322.

Next, operating the network application 12 in a state where the operations of the network 11 are started and the network 11 is operable is described. In other words, the operations of the network 11 have been started during the following operations.

When an operation of activating the network application 12 is conducted by an operation unit (not shown), the network application 12 notifies the connection information management unit 20 of the ISP identifier of the ISP 320 and obtains connection information #2 corresponding to the application from the connection information management unit 20, in order to connect to the application server 322 of the ISP 320. The network application 12 adds the application identifier to the connection information #2 and outputs the connection information #2 to the connection session management unit 30 to make a connection request.

When the connection session management unit 30 receives the connection request from the network application 12, the connection session management unit 30 checks whether the designated data link has already been established, by referring to the connection information #2 added to the connection request. The connection session management unit 30 queries the connection state management table to check whether the data link has already been established. If the data stored in the connection state management table include the information matching the connection information #2, the connection session management unit 30 discriminates that the data link #2 has already been established. If the data do not include such information, the connection session management unit 30 discriminates that the data link #2 has not yet been established.

In a case where the data link #2 has not yet been established, the connection session management unit 30 makes the connection request to the call control unit 60 by employing a parameter of the connection information #2. The call control unit 60 conducts the communication control by employing the protocol for establishing the connection in the radio communication section and the cable section extending to the ISP, and makes the connection in the radio communication section and the cable section.

For this reason, the call control unit 60 transmits the generated protocol data to the radio base station 200 and the packet service node 210 through the radio communication unit 80. The call control unit 60 also controls the connection state and the radio communication unit 80 in accordance with the response and instruction received from each of the units.

When the data link #2 is established, the call control unit 60 notifies the PDP multiple control unit 70 and the radio communication unit 80 that the data link #2 has been established, together with a parameter related with this connection, starts employment of the data link #2, and notifies the connection session management unit 30 of the establishment of connection together with the identifier of the employed data link #2.

The connection session management unit 30, receiving the notification, notifies the network application 12, which is the requester of the connection, of the establishment of connection to which the identifier of the data link #2 is added, and stores in the connections state management table a set of the identifier and connection information of the data link #2 and the identifier of the network application 12, which is the requester of the connection, in association with each other. When the connection is established, the connection session management unit 30 notifies the address resolution main unit 40 and the IP protocol I/F unit 50 of the identifier of the established data link #2.

If the connection in the data link #2 has already been established, the connection session management unit 30 notifies the network application 12 of the identifier of the data link #2 and the matter that the connection has already been established, and adds the identifier of the network application 12 to the set of the data including the data link #2 in the connection state management table.

When the establishment of the connection is completed, the address of the DNS server 321 of the ISP 320 is transmitted from the packet service node 210. At this time, the employment of the data link #2 for the connection with the ISP 320 is determined, as explained above. Therefore, the address is transferred to the address resolution sub-unit 42 via the radio communication unit 80, the PDP multiple control unit 70, and the IP protocol stack sub-unit 52.

The address resolution sub-unit 42 stores the address of the DNS 321 in the memory. When the address resolution sub-unit 42 conducts the address resolution, the address resolution sub-unit 42 makes query to the DNS server 321 on the basis of the address. When the data link is open, the address resolution sub-unit 42 erases the information on the address in the memory.

When the network application 12 receives notification of the establishment of connection of the data link #2 from the connection session management unit 30, the network application 12 outputs to the address resolution main unit 40 the identifier of the data link #2 which is output from the connection session management unit 30 and the address resolution request to which the host name is added, in order to obtain the IP address on the basis of the host name of the application server 322.

When the address resolution main unit 40 receives the address resolution request from the network application 12, the address resolution main unit 40 transfers the address resolution request to the address resolution sub-unit 42 since the address resolution main unit 40 recognizes that the data link #2 is allocated to the address resolution sub-unit 42.

The address resolution sub-unit 42 creates a format for DNS server query from the parameter of the host name included in the transferred address resolution request, and transmits the IP protocol control request to the IP protocol stack sub-unit 52 corresponding to the data link #2 by regarding one of DNS server addresses prestored in the memory as a query server (DNS server 321 in this case).

When the IP protocol stack sub-unit 52 receives the IP protocol control request, the IP protocol stack sub-unit 52 packetizes this request and outputs the request to the PDP multiple control unit 70. The PDP multiple control unit 70 physically and logically multiplexes the packet data input from the IP protocol stack sub-unit 52 and transmits the multiplexed packet data to the radio base station 200 via the radio communication unit 80.

The packet data reaches the DNS server 321, in the data link #2 established between the packet service node 210 and the ISP 320, via the radio base station 200 and the packet service node 210. The DNS server 321 analyzes the packet data and detects the address resolution request. The DNS server 321 thereby queries the data which are stored in the DNS server 321 and detects the IP address of the application server 322, on the basis of the host name of the application server 322 included in the packet data.

The IP address of the application server 322 thus detected is packetized together with the control signal as a response signal, and is transmitted from the DNS server 321 to the mobile radio terminal apparatus 100, in the data link #2 established between the packet service node 210 and the ISP 320, via the radio base station 200 and the packet service node 210.

The radio communication unit 80 receives the radio signal transmitted from the radio base station 200, and demodulates and decodes the radio signal, and thereby obtains the data transmitted from the DNS server 321. Since the data are physically and logically multiplexed data, the data are demultiplexed for each data link by the PDP multiple control unit 70. The data of the data link #2, i.e. packet data transmitted from the DNS server 321, of the demultiplexed data, are output to the IP protocol stack sub-unit 52 to which the data link #2 has already been allocated.

The IP protocol stack sub-unit 52 takes out the control signal from the packet data, detects that the requester is the address resolution sub-unit 42, and transfers the packet data to the address resolution sub-unit 42. The address resolution sub-unit 42 takes out the address resolution result (IP address of the application server 322) included in the packet data and notifies the address resolution main unit 40 of the address resolution result.

The address resolution main unit 40 adds the identifier of the data link #2 to the address resolution result and notifies the network application 12, which is the requester, of the address resolution result as a result of the request. Thus, the network application 12 obtains the IP address of the application server 322 as a response to the address resolution request.

Subsequently, the network application 12 designates the IP address of the application server 322 obtained in the above manner, and the identifier of the data link #2, for the IP protocol I/F unit 50, and requests the connection and the data transmission/reception to the application server 322. After receiving this request, the IP protocol I/F unit 50 transfers the response from the application server 322 and the receive data to the network application 12.

When the IP protocol I/F unit 50 receives the user data and its transmission request, or the IP protocol control request from the network application 12, the IP protocol I/F unit 50 transfers the user data and the request to the IP protocol stack sub-unit 52 corresponding to the data link #2 included in the request.

The IP protocol stack sub-unit 52 conducts protocol transmission of the user data or the IP protocol control request transferred from the IP protocol I/F unit 50, creates the IP packet including these information items, and transmits the IP packet to the PDP multiple control unit 70 as the output of the corresponding data link #2.

The PDP multiple control unit 70 physically and logically multiplexes the user data input from the IP protocol stack sub-unit 52 and transmits the multiplexed user data to the radio base station 200 via the radio communication unit 80. The user data thereby reaches the application server 322, in the data link #2 established between the packet service node 210 and the ISP 320, via the radio base station 200 and the packet service node 210.

Oppositely, the user data transmitted from the application server 322 are packetized together with the control signal, and transmitted to the mobile radio terminal apparatus 100, in the data link #2 established between the packet service node 210 and the ISP 320, via the radio base station 200 and the packet service node 210.

The radio communication unit 80 receives the radio signal transmitted from the radio base station 200, and demodulates and decodes the radio signal, and thereby obtains the data transmitted from the application server 322. Since the data are physically and logically multiplexed data, the data are demultiplexed for each data link by the PDP multiple control unit 70.

The data of the data link #2, i.e. packet data transmitted from the application server 322, of the demultiplexed data, are output to the IP protocol stack sub-unit 52 to which the data link #2 has already been allocated.

The IP protocol stack sub-unit 52 takes out the user data and the control signal from the packet data by conducting the IP protocol reception, adds the identifier of the data link #2 to the user data and the control signal, and outputs the user data and the control signal to the IP protocol I/F unit 50. The IP protocol I/F unit 50 adds the identifier of the data link #2 corresponding to the IP protocol control signal to the user data input from the IP protocol stack sub-unit 52, and outputs the user data to the network application 12. As described above, the user data are transmitted and received in the data link #2, between the network application 12 and the application server 322.

After that, in a case where the network application 11 newly makes an address resolution request, the network application 11 makes the address resolution request to the DNS server 311, in the data link #1, via the address resolution main unit 40, the address resolution sub-units 41 and the IP protocol stack sub-unit 51, and the DNS server 311 conducts the address resolution. Similarly, in a case where the network application 12 newly makes an address resolution request, the network application 12 makes the address resolution request to the DNS server 321, in the data link #2, via the address resolution main unit 40, the address resolution sub-units 42 and the IP protocol stack sub-unit 52, and the DNS server 321 conducts the address resolution.

When the sequence of the data transmission and reception is completed, the network application 11 makes an opening request to the connection session management unit 30 by designating the identifier of the data link #1 to open the data link #1.

When the connection session management unit 30 receives the opening request from the network application 11, the connection session management unit 30 queries the connection state management table on the basis of the identifier of the data link 31 added to the request and erases the identifier of the network application 11, which is the requester of the opening request, in the connection state management table.

If the data link #1 is associated with the other network application in the connection state management table, the data link #1 is in use. Therefore, the connection session management unit 30 notifies the network application 11, which is the requester of the opening request, that the requested processing is terminated, without opening the data link #1.

If the data link #1 is not associated with the other network application, the data link #1 is out of use. Therefore, the connection session management unit 30 makes the opening request to the call control unit 60. The call control unit 60 notifies the PDP multiple control unit 70 and the radio communication unit 80 that use of the data link #1 is terminated, and opens the data link #1.

When the opening is completed, the call control unit 60 notifies the connection session management unit 30 that the opening is completed. The connection session management unit 30, receiving the notification, notifies the network application 11, which is the requester of the opening request, that the processing is terminated, and notifies address resolution main unit 40 and the IP protocol I/F unit 50 that the data link #1 is opened, together with the identifier of the opened data link #1.

The connection session management unit 30 queries the connection state management table on the basis of the identifier of the opened data link #1, and erases the identifier of the opened data link #1 and the connection information associated with the identifier, in the connection state management table.

Opening the data link #2 by the network application 12 is not explained since opening the data link #2 is conducted in a similar manner to opening the data link #1.

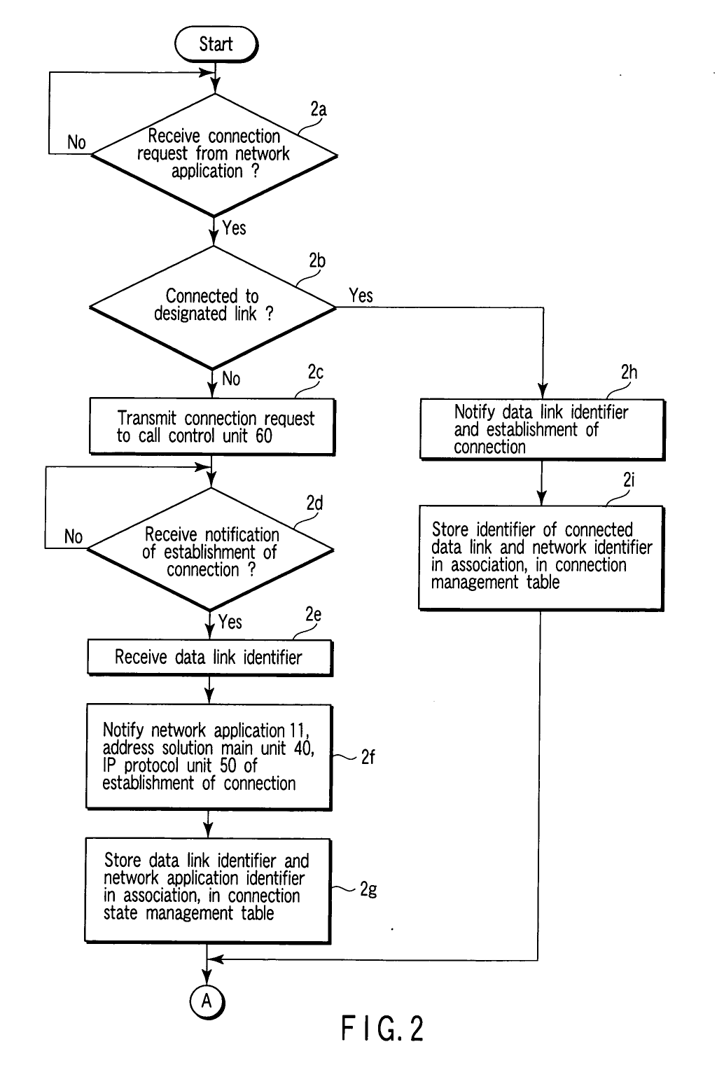

Next, concrete operations of the connection session management unit 30 during the above-described operations are described. FIG. 2 is a flowchart of the concrete operations in a case of operating, for example, the network application 11.

First, in step 2a, the connection session management unit 30 discriminates whether or not the connection request from the network application 11 is received. If the connection request from the network application 11 is received, the flow shifts to step 2b. If the connection request is not received, the connection session management unit 30 discriminates again in step 2a whether or not the connection request is received.

In step 2b, the connection session management unit 30 checks whether the designated data link has already been established, by referring to the connection information #1 added to the connection request. To checks whether the designated data link has already been established, the connection session management unit 30 queries the connection state management table. If the data stored in the connection state management table include the information matching the connection information #1, the connection session management unit 30 discriminates that the data link #1 has already been established, and the flow shifts to step 2h. If the data do not include such information, the connection session management unit 30 discriminates that the data link #1 has not yet been established, and the flow shifts to step 2c.

The connection session management unit 30 makes the connection request to the call control unit 60 by using the parameter of the connection information #1 in step 2c, and the flow shifts to 2d.

In step 2d, the connection session management unit 30 stands by a notification of establishment of the connection including the identifier of the used data link #1 from the call control unit 60. If the connection session management unit 30 receives the notification, the flow shifts to step 2e. If the connection session management unit 30 does not receive the notification, the connection session management unit 30 stands by the notification again in step 2d.

The connection session management unit 30 receives the notification of the establishment of the connection including the identifier of the used data link #1 in step 2e, and the flow shifts to step 2f.

The connection session management unit 30 notifies the network application 11, which is the requester of the connection, the address resolution main unit 40, and the IP protocol I/F unit 50 or the establishment of the connection to which the identifier of the data link #1 is added, in step 2f, and the flow shifts to step 2g.

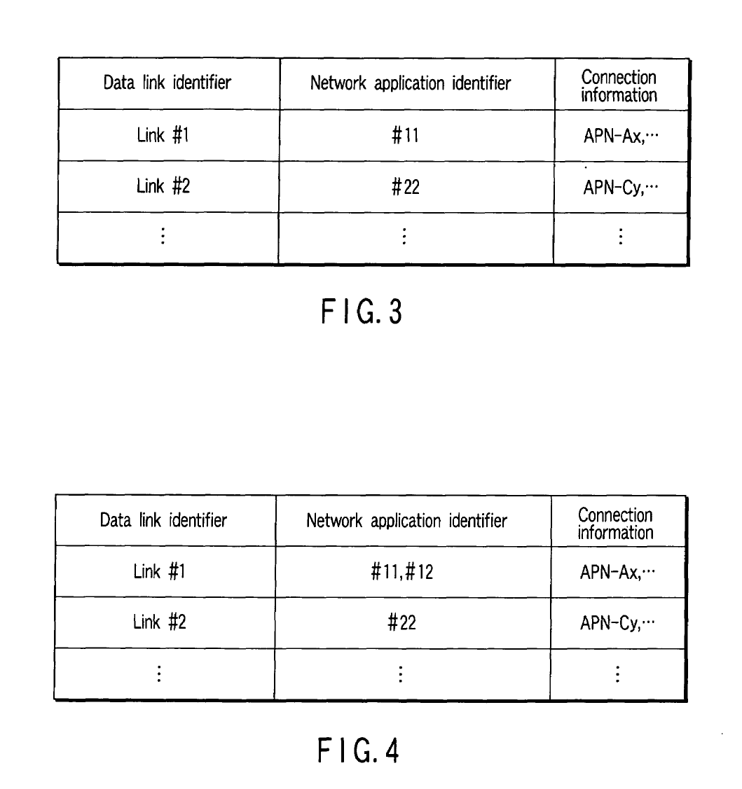

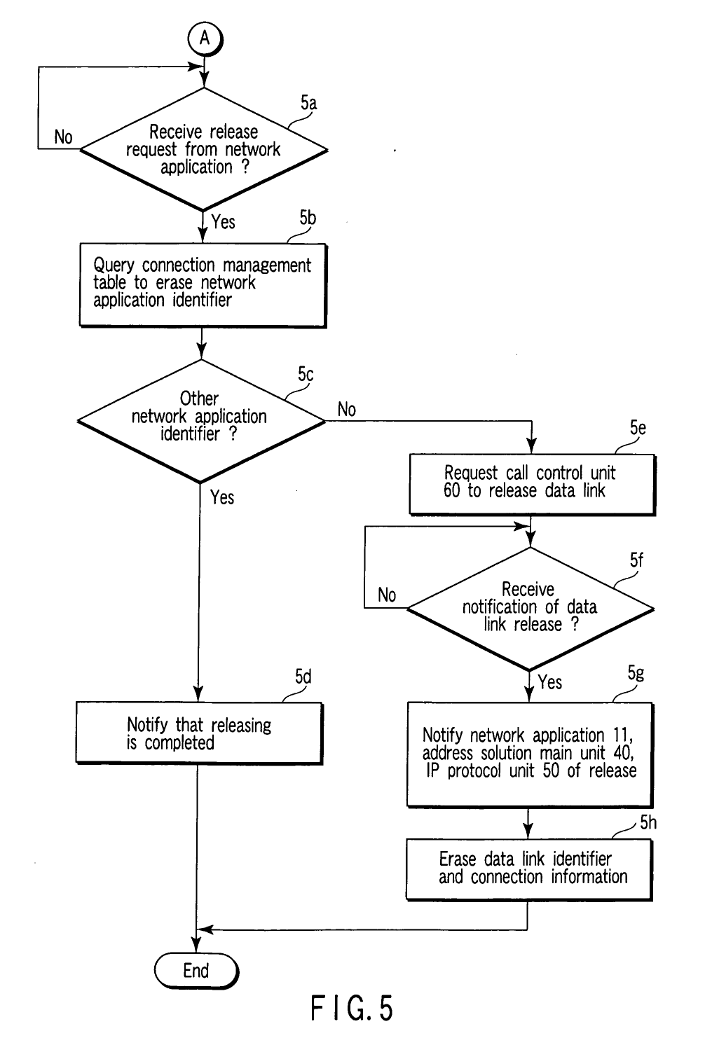

In step 2g, the connection session management unit 30 stores a set of the identifier of the data link #1, the connection information and the identifier of the network application 11, which is the requester of the connection, in association with one another, in the connection state management table, as shown in, for example, FIG. 3. Then, the flow shifts to step 5a.

In a case where the establishment of the connection in the data link #1 has already been conducted, i.e. in step 2h, the connection session management unit 30 notifies the network application 11 that the establishment of the connection has already been conducted, together with the identifier of the data link #1, and the flow shifts to step 2i.

The connection session management unit 30 adds the identifier of the network application 11, which is the requester of the connection, to the set of the data including the data link #1 in the connection state management table, in step 2i, and the flow shifts to step 5a.

In other words, for example, if the requester is the network application 12 in step 2h in which the set of the data shown in FIG. 3 are stored in the connection state management table, the identifier of the network application 12 which is the requester of the connection is added to the set of the data including the data link #1 as shown in FIG. 4.

In step 5a, the connection session management unit 30 discriminates from which network application (11 or 12) the opening request has been received. In the following descriptions, it is assumed that the network application 11 using the data link #1 has made the opening request.

If the opening request has been received from the network application 11, the flow shifts to step 5b. If the opening request has not been received, the connection session management unit 30 discriminates again in step 5a whether or not the opening request has not been received.

In step 5b, the connection session management unit 30 queries the connection state management table on the basis of the identifier of the data link #1 added to the request and erases the identifier of the network application 11 which is the requester of the opening request, in the connection state management table. Then, the flow shifts to step 5c.

In step 5c, the connection session management unit 30 discriminates whether or not the network application (12) other than the network application 11 which has made the opening request, is associated with the data link #1, in the connection state management table. If the network application 12 is associated with the data link #1, the flow shifts to step 5d since the data link #1 is used by the network application 12. If the network application 12 is not associated, the flow shifts to step 5e since the data link #1 is not used by the network application 12.

In step 5d, the connection session management unit 30 notifies the network application 11, which has made the opening request, that the processing is terminated, and terminates the processing.

In step 5e, the connection session management unit 30 makes the opening request of the data link #1 to the call control unit 60. The flow shifts to step 5f.

In step 5f, the connection session management unit 30 discriminates whether or not a notification indicating that the opening has been completed is received from the call control unit 60. If the notification is received, the flow shifts to step 5g. If the notification is not received, the connection session management unit 30 discriminates again in step 5f whether or not the notification is received.

In step 5g, the connection session management unit 30 notifies the network application 11 which has made the opening request of the termination of the processing, and notifies the address resolution main unit 40 and the IP protocol I/F unit 50 that the link is opened, together with the identifier of the opened data link #1. The flow shifts to step 5h.

In step 5h, the connection session management unit 30 queries the connection state management table on the basis of the identifier of the opened data link #1, erases the identifier of the data link #1 and the connection information associated with the identifier thereof, in the connection state management table, and terminates the processing.

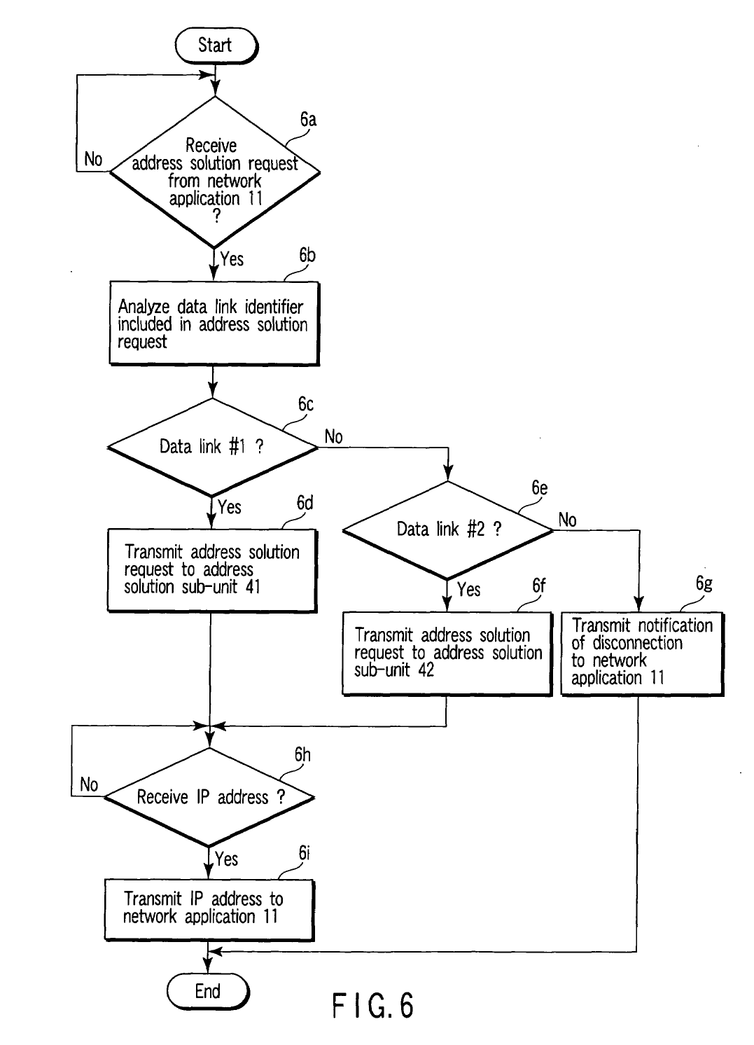

Next, concrete operations of the address resolution main unit 40 in the above-described operations are described. FIG. 6 is a flowchart of the concrete operations in a case of operating, for example, the network application 11. The same operations are also conducted when the network application 12 is operated.

In step 6a, the address resolution main unit 40 discriminates whether or not the address resolution request has been received from the network application 11. If the address resolution request has been received from the network application 11, the flow shifts to step 6b. If the address resolution request has not been received, the address resolution main unit 40 discriminates again in step 6a whether or not the address resolution request has been received.

In step 6b, the address resolution main unit 40 analyzes the data link identifier included in the address resolution request. Then, the flow shifts to step 6c.

In step 6c, the address resolution main unit 40 discriminates whether or not the data link identifier included in the address resolution request represents the data link #1, on the basis of a result of the analysis in step 6b. If the data link identifier represents the data link #1, the flow shifts to step 6d. If the data link identifier does not represent the data link #1, the flow shifts to step 6e.

In step 6d, the address resolution main unit 40 transfers the address resolution request to the address resolution sub-unit 41. The flow shifts to step 6h.

In step 6e, the address resolution main unit 40 determines whether or not the data link identifier included in the address resolution request represents the data link #2, on the basis of the analysis result in step 6b. If the data link identifier represents the data link #2, the flow shifts to step 6f. If the data link identifier does not represent the data link #2, the flow shifts to step 6g.

In step 6f, the address resolution main unit 40 transfers the address resolution request to the address resolution sub-unit 42. The flow shifts to step 6h.

In step 6g, the address resolution main unit 40 transmits notification of disconnection to the network application 11 and terminates the processing.

In step 6h, the address resolution main unit 40 discriminates whether or not the address resolution result, i.e. IP address has been received from the address resolution sub-unit 41 or 42. If the IP address has been received, the flow shifts to step 6i. If the IP address has not been received, the address resolution main unit 40 discriminates again in step 6h whether or not the IP address has been received.

In step 6i, if the IP address has been received from the address resolution sub-unit 41, the address resolution main unit 40 adds the identifier of the data link #1 to the IP address and notifies the network application 11, which is the requester, of the IP address as a result of the address resolution request. Similarly, if the IP address has been received from the address resolution sub-unit 42, the address resolution main unit 40 adds the identifier of the data link #2 to the IP address and notifies the network application 11, which is the requester, of the IP address as a result of the address resolution request.

In the mobile radio terminal apparatus 100 having the above-described configuration, the address resolution sub-unit 41, the IP protocol stack sub-unit 51, and the address resolution sub-unit 42, the IP protocol stack sub-unit 52, are provided as the means for conducting the address resolution for each of the application servers 312, 322 connected to the network applications 11, 12, such that the address resolution is conducted for each connection.

Therefore, even if the mobile radio terminal apparatus 100 is connected to a plurality of different networks simultaneously, the address resolution can be properly conducted.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio terminal apparatus, conducting radio communications with a radio base station and conducting communications with a network connector which is connected to a network via the radio base station,
the apparatus being comprising:
radio communication unit configured to establish a communication link with the radio base station;
first communication unit configured to establish a first communication link with a first network connector, via the communication link;
second communication unit configured to establish a second communication link with a second network connector via the communication link;
first request control unit configured to transmit a host name to the first network connector via the first communication link and requesting an IP address; and
second request control unit configured to transmit a host name to the second network connector via the second communication link and requesting an IP address.

2. The apparatus according to claim 1, further comprising:
first output unit configured to output a first host name by an operation according to first software;
second output unit configured to output a second host name by an operation according to second software; and
third request control unit configured to output the first host name output from the first output unit to the first request control unit, and outputting the second host name output from the second output unit to the second request control unit,
the apparatus being wherein
the first request control unit transmits the first host name output from the third request control unit, to the first network connector via the first communication link, and requests the IP address.

3. The apparatus according to claim 2, wherein the second request control unit transmits the second host name output from the third request control unit, to the second network connector via the second communication link, and requests the IP address.

4. An address resolution method, in a mobile radio terminal apparatus conducting radio communications with a radio base station and conducting communications with a network connector which is connected to a network via the radio base station,
the method being comprising:
an establishing step of establishing a communication link with the radio base station;
a first communication step of establishing a first communication link with a first network connector, via the communication link;
a second communication step of establishing a second communication link with a second network connector via the communication link;
a first request step of transmitting a host name to the first network connector via the first communication link and requesting an IP address; and
a second request step of transmitting a host name to the second network connector via the second communication link and requesting an IP address.

5. The method according to claim 4, further comprising:
a first output step of outputting a first host name by an operation according to first software; and
a second output step of outputting a second host name by an operation according to second software,
the method being wherein
the first request step transmits the first host name output in the first output step, to the first network connector via the first communication link, and requests the IP address; and
the second request step transmits the second host name output in the second output step, to the second network connector via the second communication link, and requests the IP address.
